(19) United States
(12) Patent Application Publication
(10) Pub. No.: US 2004/0213356 A1
(43) Pub. Date: Oct. 28, 2004

(54) Combined digital-to-analog converter and signal filter

(76) Inventor: Joseph Patrick Burke, Carlsbad, CA (US)

Correspondence Address: Qualcomm Incorporated, Patents Department, 5775 Morehouse Drive, San Diego, CA, 92121-1714, US

(21) Appl. No.: 10/787,870

(22) Filed: Feb. 25, 2004

Related U.S. Application Data
(60) Provisional application No. 60/465,710, filed on Apr. 24, 2003.

(51) Int. Cl. H04L 27/04

(52) U.S. Cl. 375/295

(57) ABSTRACT

An electronic circuit for processing a digital signal may include a plurality of digital delay circuits, each configured to produce a delayed replica of the digital signal; a plurality of digital-to-analog converters, each configured to convert the digital signal or the delayed replica from one of the delay circuits into an analog signal; a plurality of analog gain circuits, each configured to adjust the analog signal from one of the digital-to-analog converters by a gain factor and each having an output; and an analog summer configured to sum the outputs of the analog gain circuits. The number of delay circuits and the magnitude of the delays and gains may be selected to cause the circuit to function as a band pass filter, a high pass filter, a low-pass filter, a notch filter, or any other type of filter. The circuit may be used in a broad variety of applications, including a transceiver (such as a subscriber station) and in ultra wideband applications.

### CROSS-REFERENCE TO RELATED APPLICATION

This application claims priority to U.S. Provisional application No. 60/465,710, filed Apr. 24, 2003, entitled “Combined Digital-Analog Converter and Signal Filtering.” The entire content of this provisional application is incorporated herein by reference.

### FIELD

This application relates to electronic filters, including low-pass filters, and to digital-to-analog converters. This application also relates to Ultra Wideband communication systems.

### BACKGROUND

An electronic filter is a circuit that passes signals having certain frequencies and blocks signals having other frequencies. A filter that only passes signals below a certain frequency is commonly referred to as a low-pass filter; a filter that only passes signals above a certain frequency is commonly referred to as a high-pass filter; a filter that only passes signals within a range of frequencies is commonly referred to as a band pass filter; and a filter that only passes signals outside of a range of frequencies is commonly referred to as a notch filter.

Filters are traditionally designed to operate upon either analog or digital signals.

An analog filter typically processes a continuously-varying signal. Analog filters typically include resistors, capacitors and, in some instances, inductors. The function that is provided by an analog filter is typically determined by the number and value of the components that are selected and by the manner in which they are interconnected.

A digital filter typically processes a signal that alternates between a number of discrete levels, such as between two or three levels. Digital filters typically include serially-connected digital delay circuits, digital weighting (multipliers) circuits, and digital summers. The function that is provided by a digital filter is typically determined by the number of digital delay circuits, the magnitude of each delay, and the weighting of each weighting circuit.

Digital and analog filters are used in a broad variety of applications. A low-pass filter, for example, is often used in a transmitter to ensure that the transmitter does not transmit signals above the frequency authorized for communication by the FCC.

Some transmitters receive the information that is to be transmitted in a digital format. In these systems, the digital information signal is often converted to an analog signal by a digital-to-analog converter before it is transmitted.

In these digital information systems, the needed low-pass filter can be placed either before or after the digital-to-analog converter. If the low-pass filter is placed before the digital-to-analog converter, as shown in FIG. 1(a), the low-pass filter is typically a digital filter. If the low-pass filter is placed after the digital-to-analog converter, as shown in FIG. 1(b), the low-pass filter is typically an analog filter.

New Ultra Wideband technology may enable wireless communication devices to simultaneously communicate wirelessly at an extremely low power level (e.g., 10 nW/MHz) within an extremely wideband of several GHz and at speeds ranging from 1 MBps to 1 GBps.

However, the allowable bandwidth is not unlimited and thus may therefore still need to be controlled. To accomplish this, a low-pass filter may be used. The low-pass filter may need an extremely wide bandwidth to be able to faithfully process signals at an extremely low power level, but sharply cut off signals that are above the cutoff.

One approach is to convert the digital information signal to an analog signal and to then deliver the analog signal through an analog low-pass filter, as shown in FIG. 1(b). Unfortunately, the analog filter may not be able to faithfully pass signals within an ultra wide bandwidth, while at the same time sharply cutting off signals above the cut off. To the contrary, an analog low-pass filter that has the required bandwidth and sharply cuts off signals above the cut off may distort the signals that are passed both in amplitude and by shifting their phase in an amount that varies as a function of their frequency. Analog low-pass filter designs that approach the necessary criteria may also be quite sensitive to variations in the value of their components, possibly requiring expensive components whose tolerances are closely regulated and not subject to significant changes due to varying environments. The necessary low-pass criteria may also require designs that are complex, expensive and hard to implement with analog circuitry.

As indicated above and as shown in FIG. 1(a), the low-pass filter in a transmitter can instead be inserted before the digital-to-analog converter. In this case, the low-pass filter may need to be a digital filter. If this configuration is used in connection with an Ultra Wideband transmitter, however, the necessary digital-to-analog converter may need to operate at an extremely high frequency and to simultaneously process a large number of bits to obtain the needed filtering resolution. This may increase the size, power and speed requirements of the digital-to-analog converter, as well as its cost. Indeed, there may not currently even be a practical digital-to-analog converter that can meet all of the necessary requirements for the new Ultra Wideband wireless communication devices.

### SUMMARY

An electronic circuit for processing a digital signal may include a plurality of digital delay circuits, each configured to produce a delayed replica of the digital signal; a plurality of digital-to-analog converters, each configured to convert the digital signal or the delayed replica from one of the delay circuits into an analog signal; a plurality of analog gain circuits, each configured to adjust the analog signal from one of the digital-to-analog converters by a gain factor and each having an output; and an analog summer configured to sum the outputs of the analog gain circuits.

An electronic filter may include an analog summer having a plurality of inputs; a plurality of analog gain circuits, each having an output coupled to one of the inputs of the analog signal summer and an input; a plurality of digital-to-analog converters, each having an output coupled to the input of one of the analog gain circuits and an input; and a plurality of serially-coupled digital delay circuits, each having an output coupled to the input of one of the plurality of digital-to-analog converters.

A method may include creating a set of digital replicas of a digital signal, each of the digital replicas being substantially the same as the digital signal, but delayed in time from the digital signal by an amount different than the delays of the other digital replicas; converting the digital signal and each of the delayed digital replicas of the digital signal into an analog signal; applying a gain factor to each of the analog signals; and summing the weighted analog signals.

An electronic circuit may include means for creating a set of digital replicas of a digital signal, each of the digital replicas being substantially the same as the digital signal, but delayed in time from the digital signal by an amount different than the delays of the other digital replicas; means for converting the digital signal and each of the delayed digital replicas of the digital signal into an analog signal; means for applying a gain factor to each of the analog signals; and means for summing the weighted analog signals.

Other embodiments will become readily apparent to those skilled in the art from the following detailed description, wherein only embodiments are shown and described. The details are also capable of modification in various other respects, all without departing from the spirit and scope of what is disclosed. The drawings and detailed description are to be regarded as illustrative in nature and not as restrictive.

### BRIEF DESCRIPTION OF DRAWINGS

Aspects of the present application are illustrated by way of example, and not by way of limitation, in the accompanying drawings, wherein:

FIGS. 1(a) and (b) are block diagrams of prior art digital-to-analog converters that include a low pass filter.

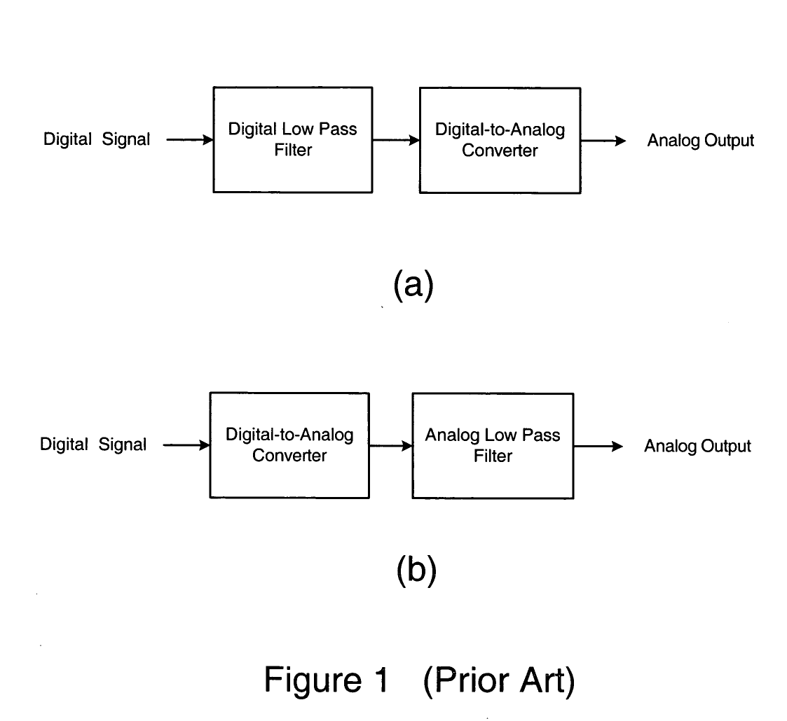

FIG. 2 is a block diagram of a combined digital-to-analog converter and signal filter.

FIG. 3 is a flow diagram of a combined digital-to-analog converter and signal filter.

FIG. 4 is a block diagram of a transmitter using a low-pass digital-to-analog converter.

FIG. 5 is a block diagram of a transceiver, such as used in a wireless communication device, using a low-pass digital-to-analog converter.

### DETAILED DESCRIPTION

The detailed description set forth below in connection with the appended drawings is exemplary and does not represent the only embodiments that can be practiced. The term “exemplary” means “serving as an example, instance, or illustration,” and should not necessarily be construed as preferred or advantageous over other embodiments. The detailed description includes specific details for the purpose of providing a thorough understanding of what is disclosed. In some instances, well-known structures and devices are shown in block diagram form in order to most clearly present the concepts. However, it will be apparent to those skilled in the art that these concepts may be practiced without these specific details.

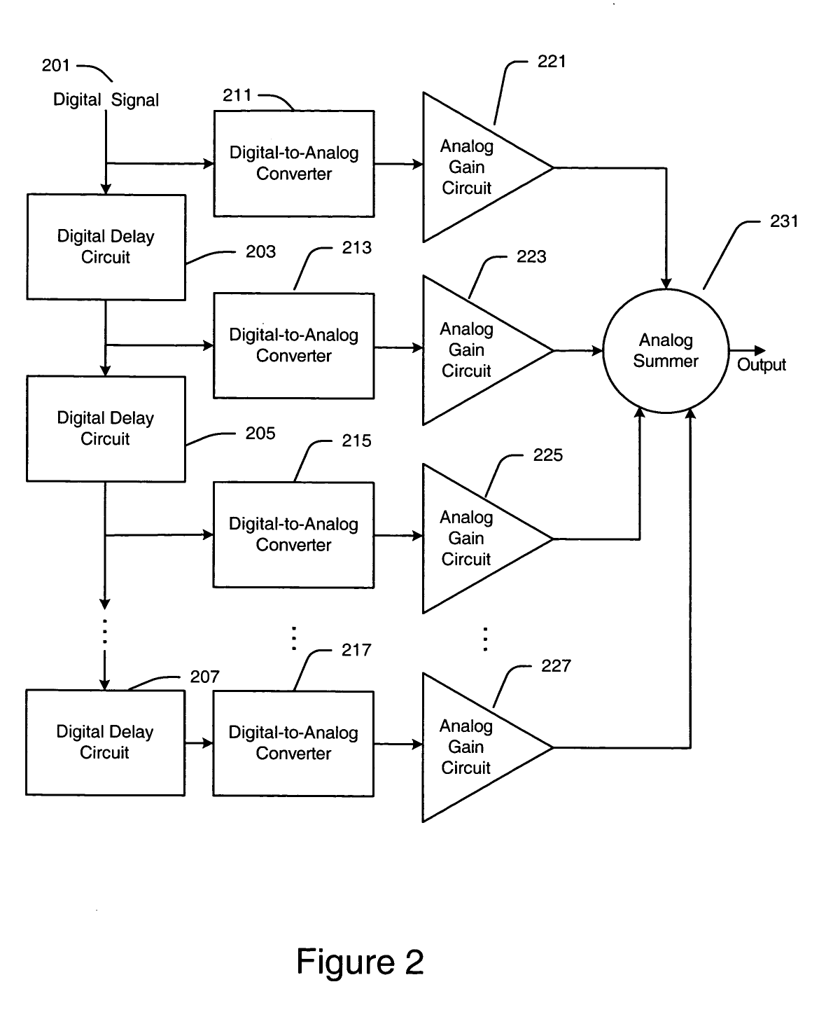

FIG. 2 is a block diagram of a combined digital-to-analog converter and signal filter.

As shown in FIG. 2, a digital signal 201 may be delivered into a series of digital delay circuits, such as digital delay circuits 203, 205 and 207.

Although the digital delay circuits are shown in FIG. 2 as being coupled in a series, they could, instead, be coupled to the digital signal 201 in parallel, in a mixture of series or parallel, or in any other configuration.

Each digital delay circuit may be configured to create an replica of the digital signal 201, but delayed by a pre-determined amount in time. Each delay circuit may consist of only a single delay element or a series of cascaded delay elements.

The original and each delayed replica of the digital signal 201 may be delivered to the input of a digital-to-analog converter, such as to the inputs of digital-to-analog converters 211, 213, 215 and 217 shown in FIG. 2. As is well known, a digital-to-analog converter is a circuit that converts a digital signal into its analog equivalent.

The analog output of each digital-to-analog converter may be delivered to the input of an analog gain circuit, such as to the inputs of analog gain circuits 221, 223, 225 and 227. As is well known, an analog gain circuit is an electronic circuit that produces an output that is substantially the same as its input, except multiplied by a pre-determined gain factor.

The output of each analog gain circuit may be delivered to the input of an analog summer, such as to the inputs of an analog summer 231 shown in FIG. 2. As is well known, an analog summer is an electronic circuit that produces an output that is substantially equal to the sum of its analog inputs. This output may optionally be multiplied internally by a gain factor within the analog summer.

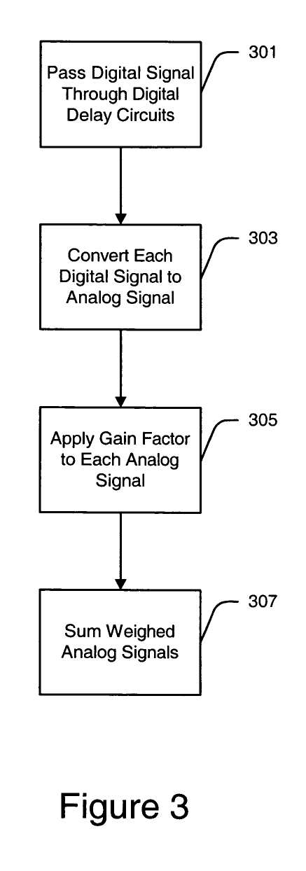

FIG. 3 is a flow diagram of a combined digital-to-analog converter and signal filter. It illustrates the process implemented by the circuit described above in connection with FIG. 2.

Specifically, the process may begin by passing the digital signal through a set of delay circuits, as reflected by a Pass Digital Signal Through Delay Circuits step 301.

The original and each delayed digital signal may then be converted to an analog signal, as reflected by a Convert Each Digital Signal To Analog Signal step 303.

A gain factor may be applied to each analog signal, as reflected by an Apply Gain Factor To Each Analog Signal step 305. The weighted analog signals may then be summed, as reflected by a Sum Weighted Analog Signals step 307.

The number of the digital delay circuits that are utilized, as well as the magnitude of each delay and the gain factor of each analog gain circuit, may vary widely. These criteria may be selected such that the circuit in FIG. 2 implements a filtering function. The exact filtering function that is implemented may similarly be governed by the specific selections that are made.

As will be apparent to those skilled in the art, the circuitry configuration shown in FIG. 2 is similar to the configuration of a traditional digital filter. However, a traditional digital filter usually utilizes a digital gain circuit in place of the digital-to-analog converter and the analog gain circuit shown in FIG. 2 (e.g., the digital-to-analog converter 211 and the analog gain circuit 221).

Notwithstanding this difference, the considerations that go into selecting the number of digital delay circuits and the magnitude of each delay and gain factor in a digital filter may also be applied to the corresponding components shown in FIG. 2.

Using this knowledge in the art of digital filter design, the number of digital delay circuits and the magnitude of each delay and gain factor in FIG. 2 may be selected to implement almost any filter design, such as a low-pass filter, high-pass filter, band pass filter or notch filter. Further, the exact specification of the filter (including the number and placement of the zeros) can similarly be controlled by applying the knowledge that has been generated in connection with digital filter design.

The number of bits in each word of the digital signal 201 may also vary widely. In one example, the digital signal 201 may consist of only a single-bit digital word. In this case, the digital delay circuits, such as the digital delay circuits 203, 205 and 207, and the digital-to-analog converters, such as the digital-to-analog converters 211, 213, 215 and 217, may be configured to process only a single bit word.

The ratio of the number of digital delay circuits to the number of digital-to-analog converters (and associated analog gain circuits) may also vary. In the example shown in FIG. 2, the number of digital-to-analog converters (and associated analog gain circuits) is equal to the number of digital delay circuits, plus one.

The combined digital-to-analog converter and signal filter that has thus-far been described may be used in a broad variety of applications.

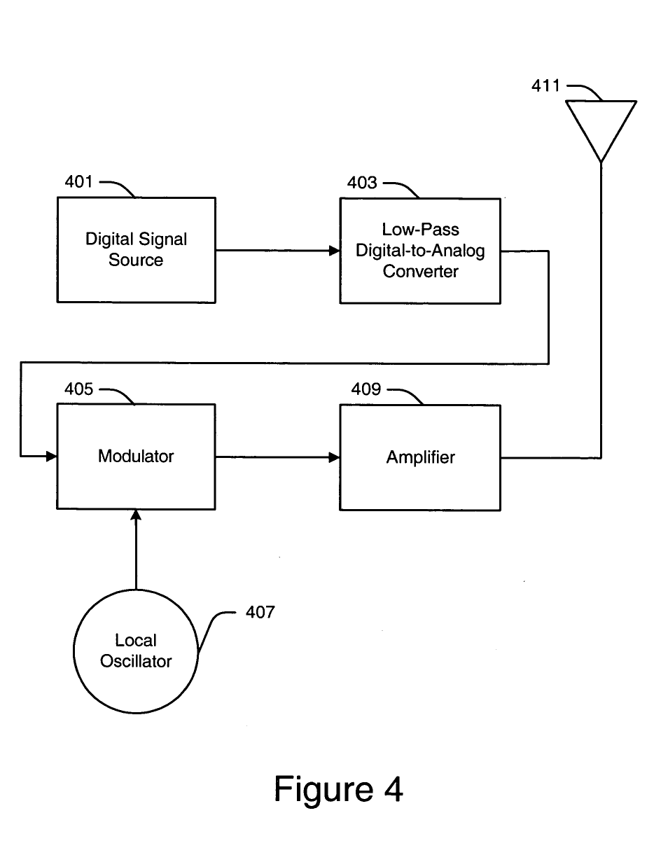

FIG. 4 is a block diagram of a transmitter using a low-pass digital-to-analog converter. As shown in FIG. 4, a digital signal source 401 may be used to deliver the information signal that is to be transmitted in a digital format. This information signal could be representative of a voice, music, video, data or any other type of information or a combination of these types.

To ensure that the digital signal provided by the digital signal source 401 does not go above a needed cutoff, the digital signal may be delivered to a low-pass digital-to-analog converter. The low-pass digital-to-analog converter may be a combined digital-to-analog converter and signal filter, such as the circuit illustrated in FIG. 2 and implementing the process illustrated in FIG. 3, all as described above in more detail. In this example, the number of digital delay circuits and the magnitude of each delay and associated gain factor may be selected in accordance with standard digital filter design techniques to implement a low-pass digital-to-analog converter 403 that meets the necessary low-pass specification.

The output of the low-pass digital-to-analog converter 403 may be delivered to a modulator 405 that mixes the output of the low-pass digital-to-analog converter 403 with a carrier signal generated by a local oscillator 407. The output of the modulator 405 may be delivered to an amplifier 409 to increase the strength of the modulated carrier. The output of the amplifier 409 may be delivered to an antenna 411 to radiate the amplified and modulated signal. In very low power configurations, the amplifier 409 may not be present or, if present, may not be used.

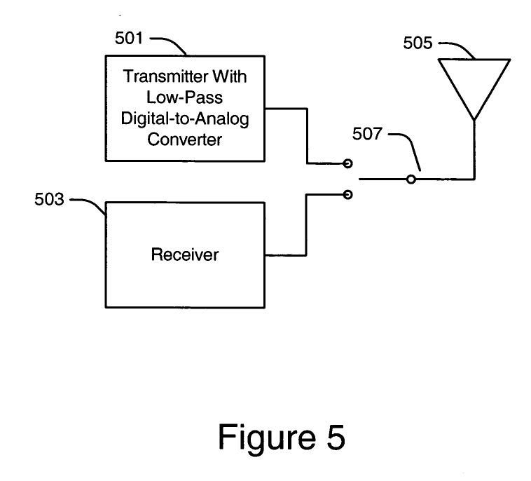

FIG. 5 is a block diagram of a transceiver that may be used in any wireless communication device and that uses a low-pass digital-to-analog converter. As shown in FIG. 5, the transceiver may include a transmitter with low-pass digital-to-analog converter 501. This may be of the type described above in connection with FIG. 4. It may also include a receiver 503 and an antenna 505 that is switched between the transmitter 501 and the receiver 503 with a switch 507. The switch 507 may be mechanically operated, voice-actuated, or operated by other means.

Although now having been discussed in the context of a transmitter (FIG. 4) and a transceiver (FIG. 5), the combined digital-to-analog converter and signal filter shown in FIG. 2 and the related process shown in FIG. 3 may be used in a broad variety of applications. For example, the combined digital-to-analog converter and signal filter may be used in connection with applications that require a finite impulse response (FIR) digital filter, as well as an infinite impulse response (IIR) digital filter. In the case of an IIR filter, circuitry may need to be added in the feedback path to match the analog output of the combined digital-to-analog converter and signal filter to the digital input.

The combined digital-to-analog converter and signal filter may support pre-correction functionality for antenna and other analog or digitally-induced amplitude and/or phase distortions.

The circuitry used in the combined digital-to-analog converter and signal filter may be incorporated into a single, mixed-mode integrated circuit chip.

Those of skill in the art will understand that information and signals may be represented using any of a variety of different technologies and techniques. For example, data, instructions, commands, information, signals, bits, symbols, and chips that may be referenced above may be represented by voltages, currents, electromagnetic waves, magnetic fields or particles, optical fields or particles, or any combination thereof.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of what is disclosed.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. In the alternative, the processor and the storage medium may reside as discrete components in a user terminal.

The previous description of the disclosed embodiments is provided to enable any person skilled in the art to make or use the concepts that are disclosed. Various modifications to these embodiments will be readily apparent to those skilled in the art, and the generic principles defined herein may be applied to other embodiments without departing from the spirit or scope of what is disclosed. Thus, the present application is not intended to be limited to the embodiments shown herein but is to be accorded the widest scope consistent with the principles and novel features disclosed herein.

What is claimed is:

1. An electronic circuit for processing a digital signal comprising:
a plurality of digital delay circuits, each configured to produce a delayed replica of the digital signal;
a plurality of digital-to-analog converters, each configured to convert the digital signal or the delayed replica from one of the delay circuits into an analog signal;
a plurality of analog gain circuits, each configured to adjust the analog signal from one of the digital-to-analog converters by a gain factor and each having an output; and
an analog summer configured to sum the outputs of the analog gain circuits.

2. The electronic circuit of claim 1 wherein the digital delay circuits, digital-to-analog converters, analog gain circuits and analog summer are configured and intercoupled in a manner that cause the circuit to perform a filtering function.

3. The electronic circuit of claim 2 wherein the delay of each digital delay circuit and the gain of each analog gain circuit is of a magnitude so as to cause the circuit to perform the filtering function.

4. The electronic circuit of claim 3 wherein the filtering function is a low-pass function.

5. The electronic circuit of claim 1 wherein the digital delay circuits are coupled in series.

6. The electronic circuit of claim 1 wherein:
each of the digital delay circuits has an output;
each of the digital-to-analog converters has an input; and
the output of each digital delay circuit is coupled to the input of one of the digital-to-analog converters.

7. The electronic circuit of claim 1 wherein:
each of the digital-to-analog converters has an output;
each of the analog gain circuits has an input; and
the output of each digital-to-analog converter is coupled to the input of one of the analog gain circuits.

8. The electronic circuit of claim 1 wherein:
each of the analog gain circuits has an output;
the analog summer has a plurality of inputs; and
the output of each analog gain circuit is coupled to one of the inputs of the analog summer.

9. The electronic circuit of claim 1 wherein each of the digital delay circuits is configured to delay a digital word having only one bit.

10. The electronic circuit of claim 1 wherein each of the digital-to-analog converters is configured to convert a digital word having only one bit.

11. The electronic circuit of claim 1 wherein:
each of the delay circuits is coupled to one of the digital-to-analog converters;
each of the analog gain circuits is coupled to one of the digital-to-analog converters; and
the analog summer is coupled to the analog gain circuits.

12. The electronic circuit of claim 1 wherein the number of the delay circuits is one less than the number of the digital-to-analog converters.

13. The electronic circuit of claim 1 further including an antenna configured to transmit the sum provided by the analog summer.

14. The electronic circuit of claim 13 further including a receiver configured to receive the received signal.

15. An electronic filter comprising:
an analog summer having a plurality of inputs;
a plurality of analog gain circuits, each having an output coupled to one of the inputs of the analog signal summer and an input;
a plurality of digital-to-analog converters, each having an output coupled to the input of one of the analog gain circuits and an input; and
a plurality of serially-coupled digital delay circuits, each having an output coupled to the input of one of the plurality of digital-to-analog converters.

16. A method comprising:
creating a set of digital replicas of a digital signal, each of the digital replicas being substantially the same as the digital signal, but delayed in time from the digital signal by an amount different than the delays of the other digital replicas;
converting the digital signal and each of the delayed digital replicas of the digital signal into an analog signal;
applying a gain factor to each of the analog signals; and
summing the weighted analog signals.

17. The method of claim 16 wherein the creating a set of digital replicas includes passing the signal through a series of digital delay circuits.

18. The method of claim 17 wherein the delay of each digital delay circuit and the gain factor applied to each analog signal causes the method to perform a filtering function.

19. The method of claim 18 wherein the filtering function is a low-pass function.

20. An electronic circuit comprising:
means for creating a set of digital replicas of a digital signal, each of the digital replicas being substantially the same as the digital signal, but delayed in time from the digital signal by an amount different than the delays of the other digital replicas;
means for converting the digital signal and each of the delayed digital replicas of the digital signal into an analog signal;
means for applying a gain factor to each of the analog signals; and
means for summing the weighted analog signals.
